(19) United States
(12) Patent Application Publication
(10) Pub. No.: US 2012/0235829 A1
(43) Pub. Date: Sep. 20, 2012

(54) SYSTEMS AND METHODS OF OILFIELD EQUIPMENT VIA INDUCTIVE COUPLING

(76) Inventors: Sarmad Adnan, Sugar Land, TX (US); Muhammad Imran Sharafat, Sugar Land, TX (US)

(21) Appl. No.: 13/050,347

(22) Filed: Mar. 17, 2011

(51) Int. Cl. G01V 3/00

(52) U.S. Cl. 340/854.9

(57) ABSTRACT

The current application discloses methods and systems for controlling various pieces of equipment at a wellsite. The method comprises deploying a first piece of oilfield equipment at a wellsite; deploying a second piece of oilfield equipment at the wellsite; connecting the first piece of oilfield equipment and the second piece of oilfield equipment with a cable, where at least one of the connections between the cable and the first piece of oilfield equipment and between the cable and the second piece of oilfield equipment is via inductively coupling. Additional pieces of oilfield equipment can be deployed at the wellsite and inductively coupled by the cable in the similar manner.

### RELATED APPLICATION DATA

None

### BACKGROUND

The statements in this section merely provide background information related to the present disclosure and may not constitute prior art. All references discussed in the current application are incorporated by reference in their entireties unless expressly indicated otherwise.

In large scale industrial operations, such as drilling, logging, cementing, or fracturing operations in the oil and gas industry, multiple pieces of equipment, such as machines, containers, pumps, mixers and so on, are often deployed at a work site to perform various tasks of the operation. Several, if not all, of these machines, containers, pumps and mixers are often connected together at the work site and controlled by a local computer unit for better coordination and execution of the operation. The connection between the local control unit and the multiple pieces of equipment is often via electrical wires, although in recent years people also tried to use local wireless network at the work site for equipment control.

However, due to the inclement environment and/or poor maintenance at the work site, electrical wires are often susceptible to mechanical wear, debris, corrosions, etc. As the number of pieces of equipment increases, the chance of connection failure will increase. Moreover, because the equipment can be set up and arranged in many different positions, each connecting electrical wire needs to be longer than the maximum possible distance between two pieces of equipment that need to be connected at the work site. This increases the total number and volume of electrical wires that need to be transported to the work site and maintained at the work site.

A local wireless network offers some benefits. However, a significant drawback associated with the use of the local wireless network is that the wireless signal transmitted on the network is often unreliable. Interferences from internal and external sources cannot be fully eliminated, and an interrupted or unstable signal may cause serious damages to the equipment or personnel at the work site.

Accordingly, a need exists for an improved system and method of controlling multiple, pieces of equipment at a work site.

### SUMMARY

According to one aspect, there is provided a method of controlling various pieces of equipment at a wellsite. The method comprises deploying a first piece of oilfield equipment at a wellsite; deploying a second piece of oilfield equipment at the wellsite; connecting the first piece of oilfield equipment and the second piece of oilfield equipment with a cable; where at least one of the connections between the cable and the first piece of oilfield equipment and between the cable and the second piece of oilfield equipment is via inductively coupling. When needed, additional pieces of oilfield equipment can be deployed at the wellsite and inductively coupled by the cable.

A sensor such as an inductive sensor or a Hall-effect sensor may be provided in the oilfield equipment so that inductively coupling can be achieved between the cable and the sensor. Optionally, two sensors are provided in the oilfield equipment for inductively coupling with the cable. Optionally, more than two sensors are provided in the oilfield equipment for inductively coupling with the cable.

The cable may comprise one strand of conductive material surrounded by one or more layers of non-conductive material. Alternatively, the cable may comprise two strands of conductive material surrounded by one or more layers of non-conductive material. In some cases, the cable originates from the first piece of oilfield equipment and ends with the first pieces of oilfield equipment to form a closed loop at the wellsite. In some other cases, the cable originates from a first point and ends at a second point that differs from the first point, therefore does not form a closed loop at the welisite. In one embodiment, a reel is provided at one or both of the first point and the second point so that any unused portion of the cable can be wound upon the reel(s) for improved tidiness and portability. In another embodiment, an emergency stop button is provided at one end or in the middle of the cable so that emergency shutdown action can be performed at the wellsite by activating the emergency stop button.

According to another aspect, there is provided a system comprising a first piece of oilfield equipment deployed at a wellsite; a second piece of oilfield equipment deployed at the wellsite; and a cable that connects the first piece of oilfield equipment and the second piece of oilfield equipment; wherein at least one of the connections between the cable and the first piece of oilfield equipment and between the cable and the second piece of oilfield equipment is via inductively coupling. In one embodiment, the first piece of oilfield equipment generates a signal that is transmitted on the cable to the second piece of oilfield equipment and can be inductively detected by the second piece of oilfield equipment. Alternatively or additionally, the second piece of oilfield equipment generates a signal that is transmitted on the cable to the first piece of oilfield equipment and can be inductively detected by the first piece of oilfield equipment. The system may further comprise a connector located on an external surface of the second piece of oilfield equipment, and the cable passes through the connector. The system may further comprise fastening device to secure the cable inside the connector.

According to a further aspect, there is provided a method comprising deploying a control unit at a wellsite; deploying a plurality of pieces of oilfield equipment at the wellsite; connecting a cable with the control unit and the plurality of pieces of oilfield equipment; effectuating a communication between the plurality of pieces of oilfield equipment and the control unit via the cable through inductive coupling. In one embodiment, said communication is to shut down one or more of the plurality of pieces of oilfield equipment at the same time. The control unit can be an emergency stop button or a computerized control system.

### BRIEF DESCRIPTION OF THE DRAWINGS

These and other features and advantages will be better understood by reference to the following detailed description when considered in conjunction with the accompanying drawings.

FIG. 1 is a schematic representation of a system for controlling various pieces of equipment performing a hydraulic fracturing operation on a well site according to one embodiment of the prior art.

FIG. 2A is a schematic representation of a system for controlling various pieces of equipment performing a hydraulic fracturing operation on a well site according to one embodiment of the current application.

FIG. 2B is an exploded view of section “2B” in FIG. 2A, illustrating a schematic representation of an inductive coupling mechanism according to one embodiment of the current application.

FIG. 2C is a cross-sectional view of an inductive coupling mechanism according to one embodiment of the current application.

FIG. 2D is a cross-sectional view of an inductive coupling mechanism according to another embodiment of the current application.

FIG. 3A is a schematic representation of a system for controlling various pieces of equipment performing a hydraulic fracturing operation on a well according to another embodiment of the current application.

FIG. 3B is a schematic representation of a double-strand cable that can be used in the system illustrated in FIG. 3A according to one embodiment of the current application.

FIG. 3C is a cross-sectional view of an inductive coupling mechanism according to one embodiment of the current application.

FIG. 3D is a cross-sectional view of an inductive coupling mechanism according to another embodiment of the current application.

FIG. 4A is a schematic representation of an inductive coupling mechanism according to another embodiment of the current application.

FIG. 4B is a cross-sectional view of the inductive coupling mechanism of FIG. 4A along axis 4B-4B′.

### DETAILED DESCRIPTION OF SOME ILLUSTRATIVE EMBODIMENTS

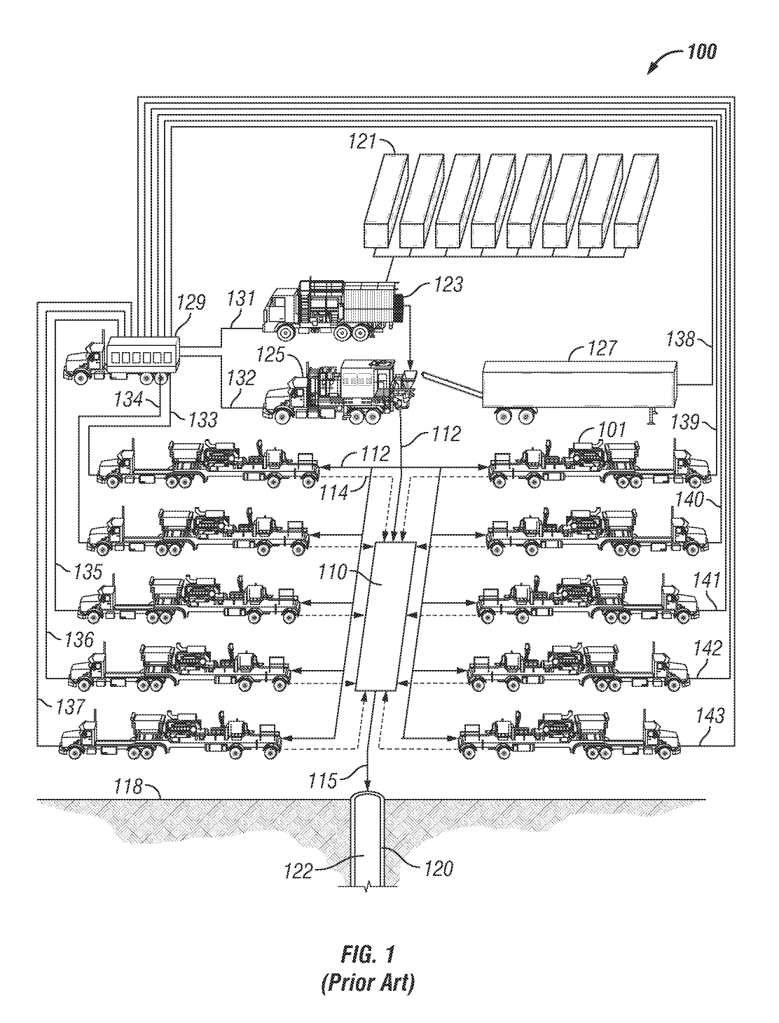

FIG. 1 illustrates a prior art system and method for controlling multiple pieces of equipment in an exemplary oilfield operation such as a hydraulic fracturing operation. The system 100 delivers a fracturing fluid from a surface 118 of a well 120 to a wellbore 122 during the fracturing treatment operation. A plurality of water tanks 121 feed water to a gel maker 123. The gel maker 123 combines water from the tanks 121 with a gelling agent to form a gel. The gel is then sent to a blender 125 where it is mixed with a proppant from a proppant feeder 127 to form a fracturing fluid. The gelling agent increases the viscosity of the fracturing fluid and allows the proppant to be suspended in the fracturing fluid. It may also act as a friction reducing agent to allow higher pump rates with less frictional pressure.

The fracturing fluid is then pumped at low pressure (for example, around 60 to 120 psi) from the blender 125 to a plurality of plunger pumps 101 as shown by solid lines 112. Each plunger pump 101 receives the fracturing fluid at a low pressure and discharges it to a common manifold 110 (sometimes called a missile trailer or missile) at a high pressure as shown by dashed lines 114. The missile 110 then directs the fracturing fluid from the plunger pumps 101 to the wellbore 122 as shown by solid line 115.

A local control unit 129, which is illustrated in FIG. 1 as a computerized control system mounted on a vehicle, may be deployed at the wellsite to coordinate the multiple pieces of equipment and control the operation of the entire system 100 for the duration of the fracturing operation.

In this prior art embodiment, each piece of equipment is connected to the local control unit 129 via an electrical wire, such as a computer network cable, a power cable, or a combination of same. For example, cable 131 connects the local control unit 129 to the gel maker 123 to control the speed or other parameters of the gel making. Cable 132 connects the local control unit 129 to the blender 125 to control the speed or other parameters of mixing the gel with the proppant. Cable 138 connects the local control unit 129 to the proppant feeder 127 to control the speed or other parameters of the proppant delivering. Finally, each of the cables 133, 134, 135, 136, 137, 139, 140, 141, 142, 143 connects the local control unit 129 to a corresponding plunger pump 101 to control the speed or other parameters of the plunger pump 101 in pumping the fracturing fluid down to the wellbore 122.

Typically, at least two electrical connections need to be established for each piece of equipment (also referred to as a “node”). One electrical connection is formed between the equipment and one end of the cable, for example by inserting the cable into an electrical connector or socket located on the body of the equipment. The other electrical connection is formed between the local control unit 129 and the other end of the cable, for example by inserting the other end of the cable into an electrical connector or socket located on the body of local control unit 129.

Because these electrical connections rely greatly on the clean contact between two conductive materials, they are highly susceptible to inclement environment. For example, in an oilfield operation, the temperature can be extremely high (e.g. more than 40° C. if the well site is located around the equator or in a desert and the operation is during a summer sunny day) or extremely low (e.g. below −20° C. if the well site is located in Alaska, Alberta or Siberia and the operation is during the winter time). The oilfield can also be wet, salty, muddy and/or dusty. Corrosive chemicals may be present in the air and in the fluid, due to gas and oil erupted from the wellbore as well as materials introduced by the oilfield operators. All such conditions may impact on the integrity of the electrical connection. Therefore, the electrical connections in the prior art system must be routinely inspected and maintained. Non-compliance with the maintenance schedule may lead to failures of the electrical connection, which may cause delays or catastrophic consequences to the oilfield operation.

Moreover, because the equipment can be set up and arranged in many different positions, each connecting electrical wire needs to be longer than the maximum possible distance between two pieces of equipment that need to be connected at the work site. This increases the total number and volume of electrical wires that need to be transported to the work site and maintained at the work site.

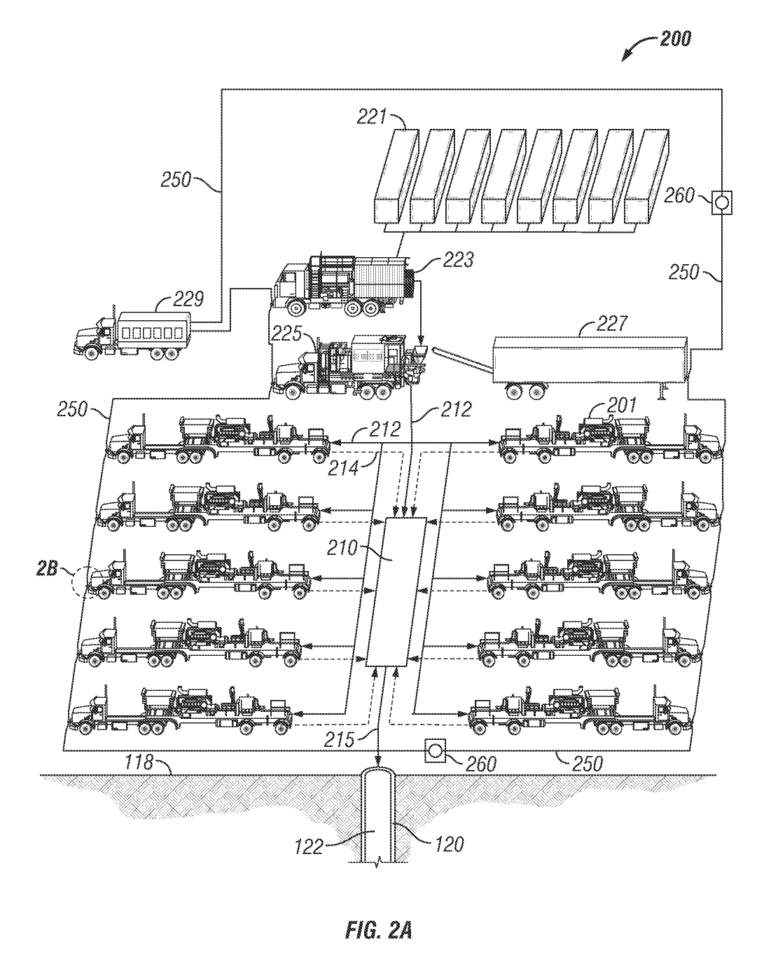

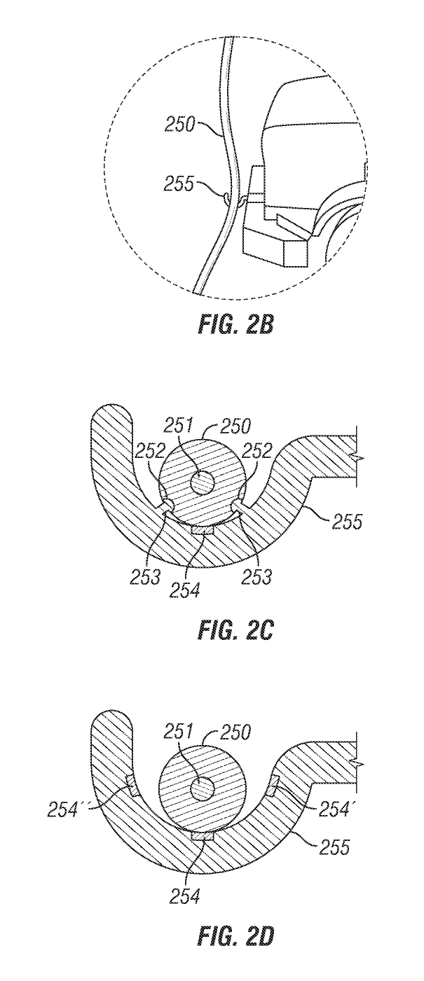

Therefore, according to one embodiment of the current application, FIG. 2A illustrates a system and method for controlling multiple pieces of equipment in an industrial operation such as a hydraulic fracturing operation in the oilfield. Similar to the system 100 described in FIG. 1 above, a system 200 as shown in FIG. 2A is provided which delivers a fracturing fluid from a surface 118 of a well 120 to a wellbore 122 during the fracturing treatment operation. A plurality of water tanks 221 feed water to a gel maker 223, which combines water from the tanks 221 with a gelling agent to form a gel. The gel is then sent to a blender 225 where it is mixed with a proppant from a proppant feeder 227 to form a fracturing fluid. The fracturing fluid is then pumped from the blender 225 to a plurality of plunger pumps 201 as shown by solid lines 212. Each plunger pump 201 receives the fracturing fluid at a low pressure and discharges it to a common manifold or missile 210 as shown by dashed lines 214. The missile 210 then directs the fracturing fluid from the plunger pumps 201 to the wellbore 122 as shown by solid line 215. A local control unit 229, which is illustrated in FIG. 2A as a computerized control system mounted on a vehicle, may be deployed at the wellsite to coordinate the multiple pieces of equipment and control the operation of the entire system 200 for the duration of the fracturing operation.

Unlike the prior art embodiment in FIG. 1 where each piece of equipment is connected to the local control unit 129 via an electrical wire, in the exemplary embodiment as shown in FIG. 2A, a single cable 250 is provided to connect multiple pieces of equipment to the local control unit 229. In the illustrated embodiment, cable 250 starts from the local control unit 229 and connects first to the gel maker 223, then the blender 225, the plurality of plunger pumps 201, the proppant feeder 227, and finally returns back to the local control unit 129 to form a closed loop.

In one embodiment, no electrical connection is formed between the cable and each piece of equipment. Instead, an inductive coupling is formed between the cable and each piece of equipment. In another embodiment, an electrical connection is formed only between the cable 250 and the local control unit 229. In yet another embodiment, an electrical connection is formed between the cable 250 and one or more pieces of equipment deployed at the wellsite, including for example the local control unit 229, but at least one an inductive coupling is formed between the cable and a piece of equipment deployed at the wellsite.

FIG. 2B shows an exploded view of one example of the inductive coupling mechanism that can be used in the current application, where a hook-shaped connector 255 is provided on the front bumper of a vehicle and the cable 250 is placed inside the cavity of the hook-shaped connector 255. It should be understood that although the connector 255 is illustrated in the shape of a hook in FIG. 2B, people skilled in the art can ready amend the connector 255 into any shape that is suitable for receiving cable 250. All such variations should be considered within the scope of the current application. Moreover, additional structures can be added to the connector 250 to improve the integrity and/or functionality of the coupling between connector 255 and connector 250. For example, a lock (not shown) can be provided at the opening of the connector 255 which can open or close the cavity of the connector 255. Other variations are possible.

FIG. 2C shows a cross-sectional view of the inductive coupling mechanism in FIG. 2B where the cable 250 rests in the cavity of the hook-shaped connector 255. In the illustrated embodiment, cable 250 comprises a conductive core 251 (such as a strand of copper wire) and an insulation layer surrounding the conductive core 251. In one embodiment, the cable can be secured to a predetermined position inside the cavity of the connector 255 by a set of fasteners 252, 253. For example, as shown in FIG. 2C, a pair of protrusions 253 may be provided on the internal surface of the cavity of the connector 255, which can matingly engage (e.g. “snap in”) a pair of recesses 252 formed on the external surface of the cable 250. In such an embodiment, the cable can be secured at a location inside the cavity of connector 255 and its relative position with respect to the sensor 254 (see below) will not change during the course of an industrial operation.

For each sensor, the magnitude of the signal that is induced in the sensor and detected by the sensor typically varies depending on the proximity of the cable 250 to the sensor. If the cable 250 moves closer to the sensor, a stronger signal will be induced in the sensor and detected by the sensor. Conversely, if the cable 250 moves further away from the sensor, a weaker signal will be induced in the sensor and detected by the sensor. Therefore, when a single sensor 254 is used in the system 200, such as illustrated in FIG. 2C, it is often desirable to fasten the cable 250 to a fixed location inside the cavity of the connector 255 so that the position of the cable 250 with respect to the position of the sensor 254 does not change significantly during an operation at the work site.

The sensor 254 can be embedded in the connector 255 or be deployed at any location that is capable of detecting signals carried on the cable 250. The sensor 254 can be any type of sensor that is capable of being inductively coupled to the cable 250 without forming an electrical connection with the cable 250. The external surface of the sensor 254 can be in physical contact with the external surface of the cable 250, however, no electrical contact should be formed between the sensor 254 and the conductive core 251 of the cable 250. Stated in other words, the sensor 254 of the current application only forms inductive coupling with the cable 250; the sensor 254 does not form electrical connection or electrical coupling with the cable 250. Accordingly, the communication between the sensor 254 and the cable 250 is much more tolerant of inclement environment at an industrial work site.

In one embodiment, the sensor 254 is an inductive sensor comprising a highly permeable core, such as a ferrite core in a rod or “0” shape, surrounded by a series of conductive coils wound on the core. In another embodiment, the sensor 254 is a Hall effect sensor which is capable of detecting the current flowing through a transmitter wire such as the cable 250. Other forms and types of sensors can also be used in the current application, such as the ones disclosed in U.S. Patent Application Publication No. 2008/0007253, U.S. Pat. No. 4,438,394, U.S. Pat. No. 4,709,205, U.S. Pat. No. 6,437,555, U.S. Pat. No. 5,416,407, U.S. Pat. No. 5,874,848, and the like, the entire contents of which are incorporated by reference into the current application.

The sensor 254 can be further connected to an electrical circuit (not shown) located in the equipment (e.g. truck) where the detected signal can be amplified and analyzed. In one embodiment, a capacitor is connected in parallel to the inductor to create a parallel resonance tank circuit which resonates at a predetermined frequency transmitted on the cable 250. In such an embodiment, the parallel resonance circuit can effectively attenuate out undesired band frequencies. The output signal from the tank circuit can be fed to a high impedance amplifier and then digitized to detect the desired signature transmitted on the cable 250. Other forms of electrical circuits can also be used in the current application, such as the ones disclosed in U.S. Pat. No. 5,608,318, U.S. Pat. No. 5,796,232, U.S. Pat. No. 5,559,454, and the like, the entire contents of which are incorporated by reference into the current application.

In operation, the local control unit 229 causes a signal to be transmitted along the cable 250 from the local control unit 229 to the multiple pieces of equipment located at the work site. The signal can be in the form of a single predetermined frequency, a combination of multiple predetermined frequencies, a single digital code, or a combination of multiple digital codes. Depending on the particular setting and design of the system 200, the signal can be picked up by one predetermined sensor 254 located on one predetermined piece of equipment, i.e. a “one-to-one type of communication”. Alternatively, the signal can be picked up by a plurality of sensors 254 located on a plurality of pieces of equipment, i.e. a “one-to-more type of communication”. Moreover, the signal transmitted on cable 250 can be designed to be picked up by all sensors 254 located on all equipment that is deployed at the work site, i.e. a “one-to-all type of communication”. A mixture of one-to-one, one-to-more and one-to-all types of communication can also be designed depending on the need at the work site.

The one-to-one type of communication can be useful when a command needs to be transmitted to a single piece of equipment that is connected by the cable 250. The one-to-more type of communication can be useful when a plurality of pieces of equipment need to carry out a same action at the same time. The one-to-all type of communication can be useful in situations when all equipment deployed at the work site needs to carry out a same action at the same time, such as a “switch on” action at the beginning of a project, a “shut down” action at the end of a project, or an “emergency shutdown” action when a hazardous event occurred at the work site and the entire system needs to be urgently turned off to protect the personnel or equipment at the work site.

It should be noted that the local control station 229 does not have to be the only location where the commanding signal can be introduced into the system 200. One or more intermediate control units 260 can be positioned along the cable 250. Therefore, when situation justifies, an operator at the work site can enter commands at the intermediate control unit 260, have the commanding signal transmitted along the cable 250 and picked up by the sensors 254 located on the desired equipment, and control the activity of the desired equipment. In one embodiment, the intermediate control unit 260 is an emergency stop button so that once the emergency stop button is pressed, the cable 250 is severed or otherwise electrically disconnected so that no further signal can be transmitted on the cable 250. The sensors 254 and the circuits on the equipment can be designed in such a way that a sudden disappearing of a constant baseline signal transmitted on the cable 250 indicates a command of an emergency shutdown (or idling), and the equipment will shut down (or idle) accordingly. Alternatively, the emergency stop button can be designed in such a way that once it is pressed, a distinct frequency or digital code will be transmitted along the cable 250 to command all equipment to perform an immediate shut down or idling. Variations to these embodiments are possible and can be readily perceived by people skilled in the art upon reviewing the current application. All such variations should be considered within the scope of the current application.

FIG. 2D illustrates an alternative embodiment where multiple sensors are used in the system 200. In some cases, two sensors 254&254′, or 254&254″, or 254′&254″ are used. In some other cases, more than two sensors 254, 254′, 254″ are used. The multiple sensors can be spaced from each other at a predetermined angle. For example, in the illustrated example, the first sensor 254 is spaced approximately 90 degrees apart from the second sensor 254′, and the second sensor 254′ is spaced approximately 90 degrees apart from the third sensor 254″. Other variations are possible.

When two or more sensors 254, 254′, 254″ are used in the system, the exact position of the cable 250 in the connector 255 becomes less important. The cable 250 may vibrate, turn, slide, or otherwise change positions inside the cavity of the connector 255. Each sensor will pick up a signal from the cable 250. When the cable 250 moves closer to one sensor, the cable 250 often moves away from another sensor. Therefore, under most circumstances, the combination of signals from all sensors does not change significant so long as the cable 250 remains inside the cavity of the connector 255. Thus, a system 200 with two or more sensors is more tolerant of position changes of the cable 250. Accordingly, the fastening devices 252, 253 as shown in FIG. 2C can be eliminated when two or more sensors 254, 254′, 254″ are used in the system.

It should be noted that even only a single sensor 254 is used in the system 200, it is not absolutely necessary to have fastening devices 252, 253 to secure the cable 250 in the connector 255. For example, when the sensor 254 has an effective detection range that is equal to or greater than the maximum possible distance from the sensor 254 to the conductive core 251 of the cable 250, a single sensor 254 without any fastening devices 252, 253 can reliably detect the signal carried on the cable 250. In another example, if the signal transmitted on the cable 250 is sufficiently strong and/or unique that any position change of the cable 250 inside the cavity of the 255 will produce a relatively small variant in terms of the signal detected by the sensor 254, there would be no jeopardy to the proper interpretation of the signal transmitted on the cable 250. Accordingly, there would be no need to secure the cable 250 to the connector 255. One example of such scenario is where the system 200 is used primarily for the purpose of effectuating an emergency shutdown to the system 200 when an incidence occurs at the work site. In such a situation, the cable 250 may constantly deliver a very strong baseline signal to all equipment connected by the cable 250. When the emergency stop button 260 is pressed by the operator who has observed a hazardous situation at the well site, the strong baseline signal on the cable 250 will be terminated. The sudden disappearance of the baseline signal will be picked up by the sensor 254 no matter where the cable 250 is located inside the cavity of the connector 255. In this case, no fastening device is needed. Other variations are also possible and can be readily perceived by people skilled in the art upon reviewing the current application. All such variations should be considered within the scope of the current application.

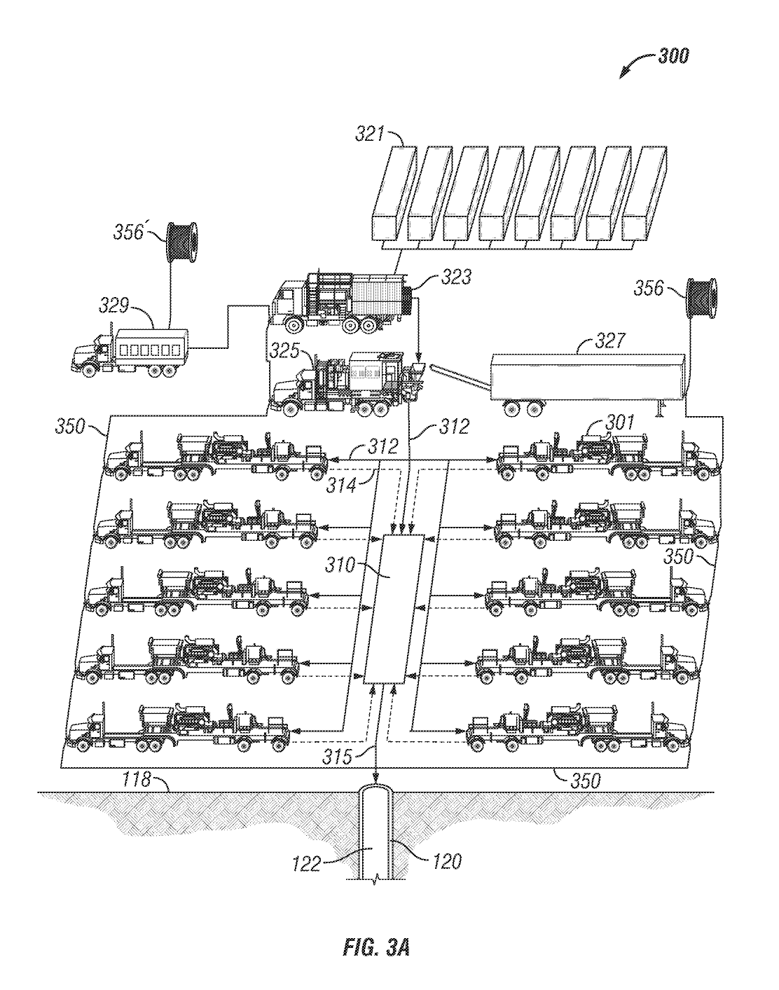

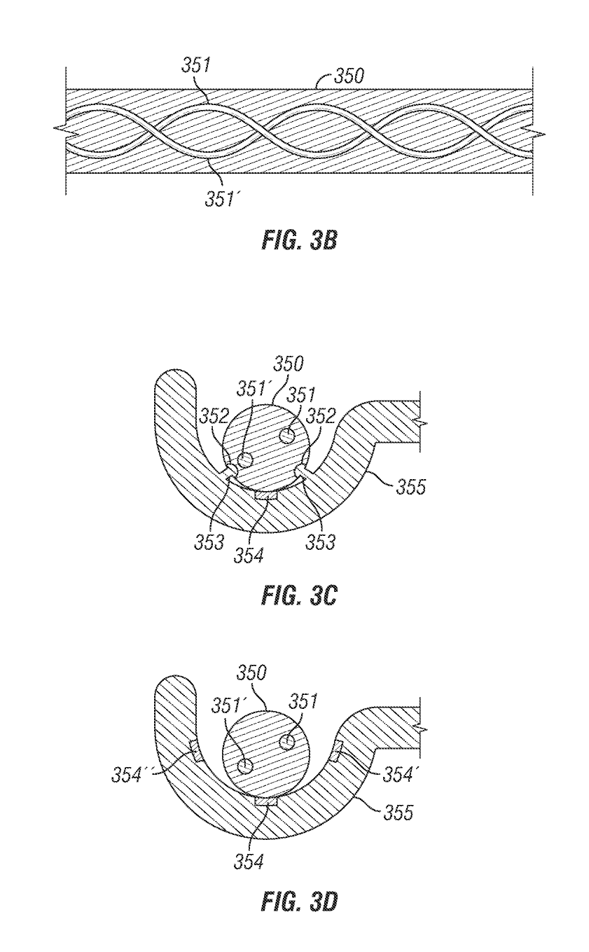

FIG. 3A to FIG. 3D illustrate a further improved system and method of the current application. Similar to the system 200 as in FIG. 2A above, a system 300 is provided in FIG. 3A which delivers a fracturing fluid from a surface 118 of a well 120 to a wellbore 122 during a fracturing treatment operation. A plurality of water tanks 321 feed water to a gel maker 323, which combines water from the tanks 321 with a gelling agent to form a gel. The gel is then sent to a blender 325 where it is mixed with a proppant from a proppant feeder 327 to form a fracturing fluid. The fracturing fluid is then pumped from the blender 325 to a plurality of plunger pumps 301 as shown by solid lines 312. Each plunger pump 301 receives the fracturing fluid at a low pressure and discharges it to a common manifold or missile 310 as shown by dashed lines 314. The missile 310 then directs the fracturing fluid from the plunger pumps 301 to the wellbore 122 as shown by solid line 315. A local control unit 329, which is illustrated in FIG. 3A as a computerized control system mounted on a vehicle, may be deployed at the wellsite to coordinate the multiple pieces of equipment and control the operation of the entire system 300 for the duration of the fracturing operation.

Unlike the embodiment in FIG. 2A where multiple pieces of equipment are connected by a single cable 250 which originates from the local control unit 129 and returns back to the local control unit 129 to form a closed loop, in the embodiment as shown in FIG. 3A, the cable 350 originates from a first point and ends at a second point that differs from the first point so that no closed loop is formed by the cable 350. In one case, as shown in FIG. 3A, the first point is a reel of cable 356′ and the second point is another reel of cable 356. In another case (not shown), the first point is the local control unit 129 and the second point is a reel of cable 356. In a further case (not shown), the first point is a reel of cable 356′ and the second point is the proppant feeder 327. In yet another case (not shown), the second point is an emergency stop button similar to the one discussed above. Other variations are possible.

The cable 350 may comprise two strands of conductive materials 351, 351′ as shown in FIG. 3B. At one and of the cable 350, the two strands of conductive materials 351, 351′ can be connected to a power source, such as an electrical connector or socket (not shown). At the other end of the cable 350, the two strands of conductive materials 351, 351′ can be connected to a resistor (not shown) or other electrical component so that the two strands 351, 351′ can form a closed circuit within the cable 350. Other variations are possible.

Referring now to FIG. 3C and FIG. 3D, when the cable 350 is placed inside the cavity of the connector 355, the signal carried on the cable 350 can be picked up by sensor 354 (FIG. 3C), or two or more sensors 354, 354′, 354″ (FIG. 3D). Fastening devices 352, 353 can be optionally included, as described above. However, in the current embodiment where two strands of conductive materials 351, 351′ are included in the cable 350, fastening devices 352, 353 are even less necessary because the sensor(s) 354, 354′, 354″ will pick up the signals from both strands of conductive materials 351, 351′. Therefore, movements such as vibrating, sliding, and twisting of cable 350 inside the cavity of the connector 355 will produce less variations to the sum of the signals induced by both strands of conductive materials 351, 351′.

The system 300 may also optionally include one or more emergency stop buttons (not shown) as described above.

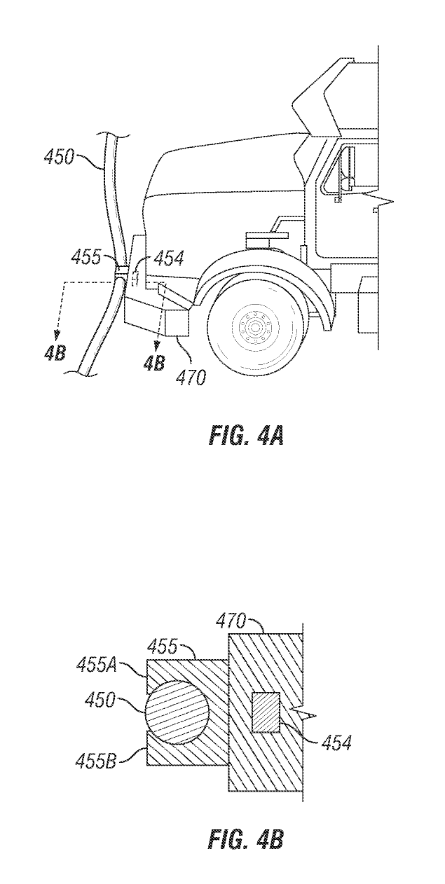

It should be noted that although the above description is set forth in the context of a hook-shaped connector 255, 355 with a cable 250, 350 passing through the connector 255, 355, variations are possible without departing from the general principle of the current application. For example, instead of having the cable 250, 350 passing straightly through the connector 255, 355, the cable 250, 350 can be looped around the body of the connector 255, 355 for one or more turns. Moreover, instead of using a hook-shaped connector 255, 355 to host the cable 250, 350, a “snap in” type of cable holder 455 can be placed on an external surface of a piece of equipment, such as the bumper 470 of a truck, as shown in FIGS. 4A and 4B. In one embodiment, the diameter of the cable 450 is larger than the opening of the connector 455 defined by the tips of the two arms 455a, 455b of the connector 455. In such an event, the cable 450 can be lodged into the cavity of the connector 455 by pressing the cable 450 against the tips of the two arms 455a, 455b, which temporarily widens the distance between the tips of the two arms 455a, 455b and allows the cable 450 to enter the cavity of the connector 455. Once the cable 450 passes the opening of the connector 455, the two arms 455a, 455b resume their initial positions and secure the cable 450 inside the cavity of the connector 455.

Moreover, in the illustrated embodiment in FIGS. 4A and 4B, the sensor 454 is embedded in the bumper 470. However, the sensor 454 can also embedded in the connector 455 in a fashion similar to that illustrated in FIGS. 2C, 2D, 3C, and 3D. In some cases, one sensor is used; in some other cases, two or more sensors are used. Other variations are also possible.

Furthermore, it should also be noted that although the above description is set forth in the context of transmitting signals from a control station to one or more pieces of equipment, the reverse can be applicable as well. That is, the equipment emits signals that can be inductively detected by the cable and transmitted along the cable to a desired location, such as the local control unit and/or another piece of equipment. In some cases, the “sensor” as described in FIGS. 2-4 above is also capable of emitting electromagnetic signals. In some other cases, the “sensor” as described in FIGS. 2-4 is further connected to a piece of hardware that is capable of emitting electromagnetic signals. In some further cases, a separate, stand alone component is used to emit electromagnetic signals that can be picked up by the cable. In any event, the system and method of the current application can be used to effectuate a two-way communication via inductive coupling.

It should also be noted that although the above description is set forth in the context of conducting a hydraulic fracturing operation in an oilfield, embodiments of the current application are also applicable to other oilfield operations including, but not limited to, drilling, cementing, logging, working over, stimulating, producing, and so on. Moreover, embodiments of the current application may also be applicable to other industries as well, such as construction, manufacture, transportation, just to name a few.

The preceding description has been presented with reference to some illustrative embodiments of the Inventors' concept, Persons skilled in the art and technology to which this application pertains will appreciate that alterations and changes in the described structures and methods of operation can be practiced without meaningfully departing from the principle, and scope of this application. Accordingly, the foregoing description should not be read as pertaining only to the precise structures described and shown in the accompanying drawings, but rather should be read as consistent with and as support for the following claims, which are to have their fullest and fairest scope.

Furthermore, none of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle. The claims as filed are intended to be as comprehensive as possible, and NO subject matter is intentionally relinquished, dedicated, or abandoned

We claim:

1. A method, comprising:
deploying a first piece of oilfield equipment at a wellsite;
deploying a second piece of oilfield equipment at the wellsite;
connecting the first piece of oilfield equipment and the second piece of oilfield equipment with a cable;
effectuating a communication between the first piece of oilfield equipment and the second piece of oilfield equipment;
wherein at least one of the connections between the cable and the first piece of oilfield equipment and between the cable and the second piece of oilfield equipment is via inductively coupling.

2. The method of claim 1, further comprising:
deploying a third piece of oilfield equipment at a wellsite;
connecting the cable with the third piece of oilfield equipment via inductively coupling.

3. The method of claim 1, wherein the connection between the cable and the first piece of oilfield equipment is an electrical connection, and the connection between the cable and the second piece of oilfield equipment is via inductively coupling, the method further comprising:
transmitting a signal from the first piece of oilfield equipment to the second piece of oilfield equipment via inductively coupling.

4. The method of claim 3, further comprising:
providing a sensor in the second piece of oilfield equipment, wherein said inductively coupling is achieved between the cable and the sensor.

5. The method of claim 4, wherein the sensor is an inductive sensor or a Hall-effect sensor.

6. The method of claim 1, further comprising:
providing two or more sensors in the second piece of oilfield equipment, wherein said inductively coupling is achieved between the cable and the two sensors.

7. The method of claim 1, wherein the cable has a first end and a second end, both connected to the first piece of oilfield equipment.

8. The method of claim 1, wherein the cable has a first end and a second end and wherein only the first end is connected to the first piece of oilfield equipment.

9. The method of claim 8, wherein at least one of the first and the second and of the cable is wound on a reel.

10. The method of claim 1, wherein both the connection between the cable and the first piece of oilfield equipment and the connection between the cable and the second piece of oilfield equipment are via inductively coupling, and the method further comprising:
transmitting a signal from the second piece of oilfield equipment to the first piece of oilfield equipment via inductively coupling.

11. A system, comprising:
a first piece of oilfield equipment deployed at a wellsite;
a second piece of oilfield equipment deployed at the wellsite;
a cable that connects the first piece of oilfield equipment and the second piece of oilfield equipment;
wherein at least one of the connections between the cable and the first piece of oilfield equipment and between the cable and the second piece of oilfield equipment is via inductively coupling.

12. The system of claim 11, wherein the connection between the cable and the first piece of oilfield equipment is an electrical connection, and the connection between the cable and the second piece of oilfield equipment is via inductively coupling; and wherein at least one sensor is provided in the second piece of oilfield equipment and said sensor is inductively coupled to the cable.

13. The system of claim 12, wherein two or more sensors are provided in the second piece of oilfield equipment.

14. The system of claim 13, wherein the sensor is an inductive sensor or a Hall-effect sensor.

15. The system of claim 11, further comprising a connector located on an external surface of the second piece of oilfield equipment, wherein the cable passes through the connector.

16. The system of claim 11, wherein both the connection between the cable and the first piece of oilfield equipment and the connection between the cable and the second piece of oilfield equipment are via inductively coupling, and at least one sensor is provided in the first piece of oilfield equipment so that the first piece of oilfield equipment is inductively coupled to the cable.

17. A method, comprising:
deploying a control unit at a wellsite;
deploying a plurality of pieces of oilfield equipment at the wellsite;
connecting the control unit and the plurality of pieces of oilfield equipment with a cable;
effectuating a communication between the control unit and the plurality of pieces of oilfield equipment via inductive coupling.

18. The method of claim 17, wherein said communication is a signal generated by the control unit, transmitted along the cable, and inductively detected by the plurality of pieces of oilfield equipment.

19. The method of claim 17, wherein said communication is a signal generated by one or more of the plurality of pieces of oilfield equipment, transmitted along the cable, and inductively detected by the control unit.

20. The method of claim 17, wherein said communication is a shutting down signal that switches off one or more of the plurality of pieces of oilfield equipment.
